(19) United States
(12) Patent Application Publication
(10) Pub. No.: US 2018/0295844 A1
(43) Pub. Date: Oct. 18, 2018

(54) METHOD AND APPARATUS FOR PIZZA PREPARATION

(71) Applicant: PHILIP J. CARCIA, MANCHESTER, CT (US)

(72) Inventor: PHILIP J. CARCIA, MANCHESTER, CT (US)

(21) Appl. No.: 15/487,140

(22) Filed: Apr. 13, 2017

(51) Int. Cl. A21D 13/41

(52) U.S. Cl. CPC A21D 13/41

(57) ABSTRACT

A method for preparation of a pizza which includes providing a crust having a peripheral edge; providing a preformed slice of cheese having (1) a substantially uniform thickness, (2) that is dimensioned and configured to extend over the crust and intermediate the peripheral edge thereof and (3) has a plurality of holes disposed therein. Thereafter, the step of positioning the preformed slice of cheese on the crust is followed by baking the crust and the preformed slice whereby gases trapped intermediate the preformed slice and the crust escape out through the holes in the preformed slice.

### TECHNICAL FIELD

The present invention is generally directed to preparation of food products. More particularly, the present invention is directed to methods and apparatus for preparation of pizza.

### BACKGROUND OF THE INVENTION

The pizza industry is characterized but a substantial number of chain pizza preparation and marketing entities as well as many smaller pizza preparation and marketing entities. There is substantial competition between such entities. The competition inherently involves the speed with which the product can be prepared, the quality of the product, and the cost of the raw materials. Traditionally, the pizza is prepared by baking a crust. Thereafter, the preparer deposits a plurality of cheese slices or a plurality of handfuls of chopped cheese onto the previously paid crust. The distribution of the slices or chopped cheese fragments is intended to be substantially uniform to maximize the quality of the resulting product. The distribution is inherently a compromise because it is impossible for the human preparer to precisely deposit the cheese in a manner that results in an exactly uniform thickness. Certainly, after the cheese is heated during the normal preparation process, the consumer is not able to precisely detect the thickness of the cheese and each possible part of the pizza. The consumer would of course recognize any gaps in the coverage of the crust by the cheese. Therefore, the preparer will instinctively add sufficient cheese to avoid any possibility that the cheese does not fully cover the crust.

The consequence of the need to prevent gaps in the coverage of the crust by the cheese and the inherent overlap of individual cheese slices or cheese fragments results in substantial thickness variations of the cheese layer on the crust. Because the cost of the cheese is the single most expensive raw material for the pizza and because the consumer cannot even perceive unusually large cheese thickness in any pizza, any thickness of the cheese layer beyond a certain baseline quantity can be a waste since any such excess is not consumer perceptible. Thus, the cost of that excess could be eliminated with no compromise of customer satisfaction.

Similarly, the time to prepare the pizza in a very competitive environment is also a significant factor for any pizza preparation and sale business. Depositing a plurality of individual slices or a plurality of handfuls of cheese fragments it is a substantial part of the time required for preparation of pizza. Thus, the cost of labor for this step is a definite consideration in attempting to improve the return on investment of any entity preparing and/or selling pizza.

From the above, it is therefore seen that there exists a need in the art to overcome the deficiencies and limitations described herein and above.

### SUMMARY OF THE INVENTION

The shortcomings of the prior art are overcome and additional advantages are provided through a method for preparation of a pizza which includes providing a crust having a peripheral edge; providing a preformed slice of cheese having (1) a substantially uniform thickness, (2) that is dimensioned and configured to extend over the crust and intermediate the peripheral edge thereof and (3) has a plurality of holes disposed therein. Thereafter, the step of positioning the preformed slice of cheese on the crust is followed by baking the crust and the preformed slice whereby gases trapped intermediate the preformed slice and the crust escape out through the holes in the preformed slice.

The method may include the step of providing a preformed slice in which the holes are arranged in a grid or in concentric rings. This step may include providing a preformed slice in which the holes have a diameter of approximately ¼ inch. This step may include providing a preformed slice in which the holes are spaced apart no less than one half inch. The step may include providing a preformed slice in which the ratio of the distance between holes and the diameter of the holes is approximately 2:1.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a partially schematic top view of a first embodiment of the present invention having a monolithic preformed slice provided with the breather holes arrayed in a grid;

FIG. 2 is a partially schematic top view of a second embodiment of the present invention having a monolithic preformed slice provided with the breather holes arrayed in concentric rings;

FIG. 3 is a partially schematic top view of a third embodiment of the present invention having a preformed slice provided with the breather holes arrayed in a grid in which the preformed slice is formed in two discrete sections; and

FIG. 4 is a partially schematic top view of a fourth embodiment of the present invention having a preformed slice provided with the breather holes arrayed in concentric rings in which the preformed slice is formed in two discrete sections.

### DETAILED DESCRIPTION

Although the description herein will focus the preparation circular features, it will be understood that the present invention may be utilized in preparation of rectangular pizza forms as well as circular forms.

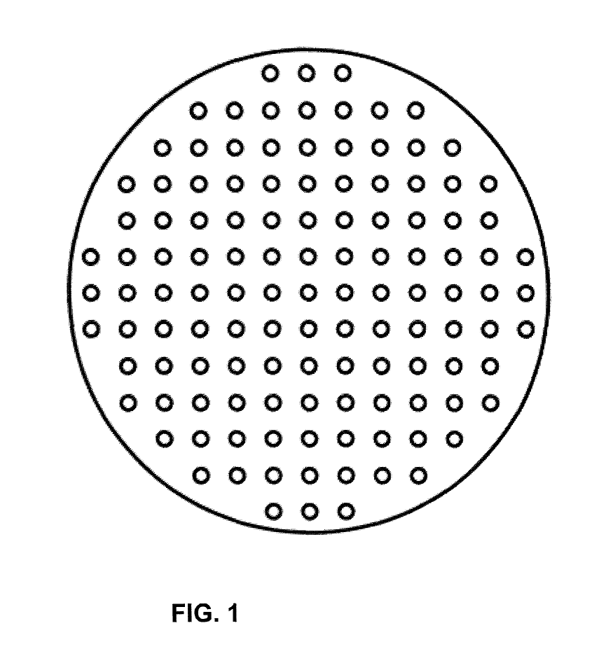

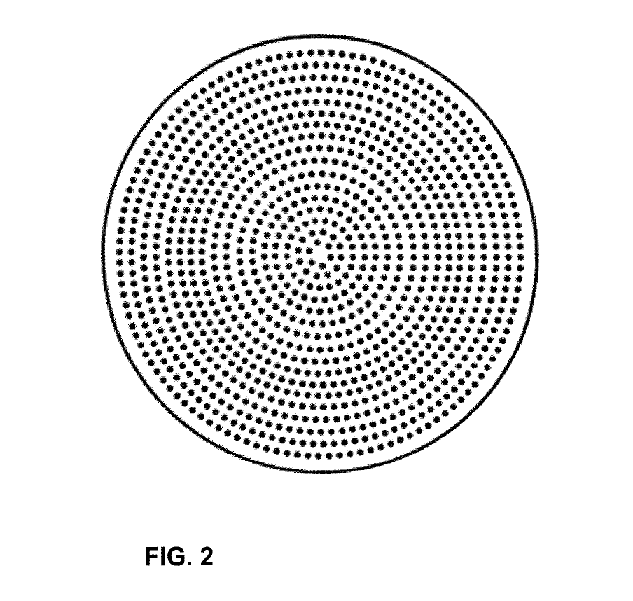

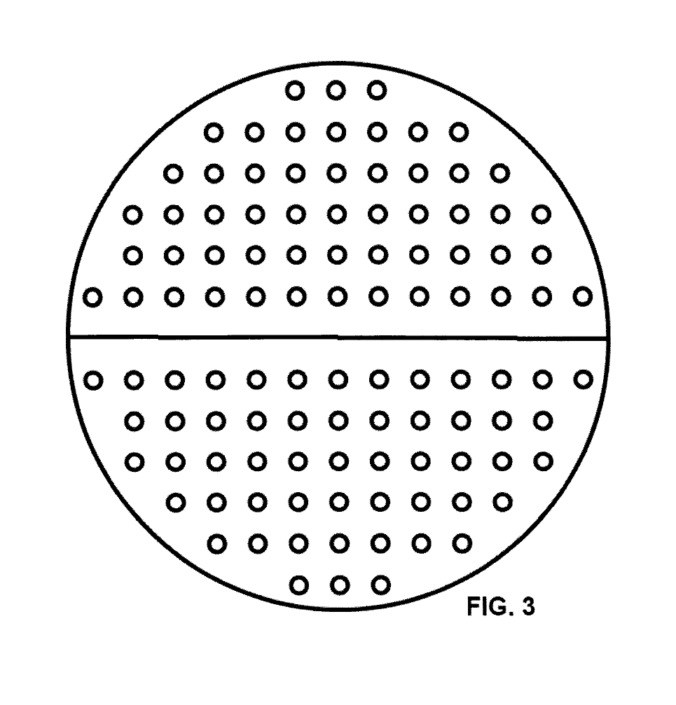

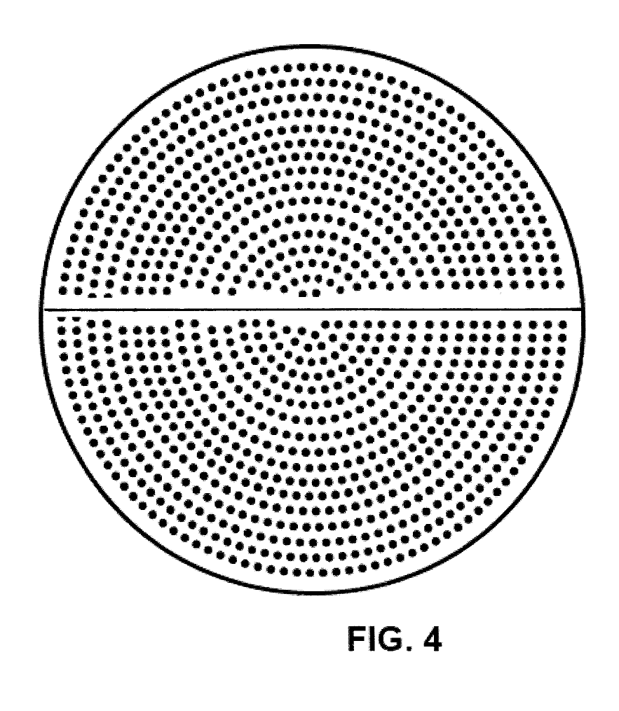

In accordance with the present invention a preformed slice is deposited on the pizza crust. The preformed slice may be a monolithic (single piece) or a plurality of pieces which are side abutting whereby the plurality of pieces collectively cover the portion of the pizza normally covered by cheese and other food products. Embodiments of the monolithic preformed slice are shown in FIGS. 1 and 2. Embodiments having a plurality of pieces that collectively form the preformed slice are shown in FIGS. 3 and 4. It will be understood that the peripheral part of both circular as well as rectangular pizzas has traditionally exposed the crust. Often the peripheral part is approximately 1 inch wide. The preformed slice is positioned in centered relationship to the periphery of the crust.

A critical aspect of the present invention is the provision of breather holes extending through the preformed slice. Such holes are imperative to prevent trapping gases, such as air, under the preformed slice. If gasses are trapped, the gases will expand dramatically as the pizza is cooked. Gas trapped under the preformed slice will cause the pizza to have the exposed face of the pizza to have a surface irregularity which may result in localized burning or discoloration proximate to the peaks of such surface irregularities.

In one embodiment, the holes have a diameter of ¼ inch holes are spaced about ½ inch apart. The preferred size and spacing will vary with (1) the temperature in the pizza oven and (2) the type of cheese as well as characteristics of the cheese made by a specific manufacturer in addition to manufacturing tolerances of that cheese manufacturer. Similarly, there is a trade-off between the size of the holes and the distance between the holes. As shown in the drawing two possible arrays for the holes are a grid orientation and concentric rings of holes. The present invention also contemplates other more random arrays.

The utilization of the method described and claimed herein will result in a savings in the labor required to prepare pizza, a more uniform product, reduction of raw material cost and facilitates more rapid pizza preparation. It will be understood that the reduction in the amount of cheese required is a consequence of both the better uniformity of the thickness as well as the holes in the preformed slice. It will be understood of course that after heating the holes are no longer apparent to the consumer.

The present invention also relates to the method of preparing the individual preformed slice or slice segments with the desired holes. The cheese manufacturing process typically involves heating milk, mixing additives such as coloring, calcium chloride, lipase, and citric acid in addition to cultures that are used to ripen the milk. Thereafter, rennet is dissolved in non-chlorinated water. The resulting curds are then placed in a mold.

Thereafter the mixture in the mold is pressed. In a preferred embodiment of the present invention a cover is provided for pressing the cheese within the mold. The cover has the general appearance of an inverted bed of nails. Such beds of nails are typically associated with circus performances and conjure up a stereotypical image of Indian mystic who lies on a bed of nails for hours. When such an inverted structure is forced downward into the quantity of cheese in a mold the required holes are formed. Thereafter, the cover is withdrawn and the block of cheese is sliced horizontally to produce a plurality of slices or sections of slices required for preparation of uniform high-quality pizza rapidly as described above.

The method in accordance with the present invention when used with smaller pizzas will typically use a monolithic preformed slice. The method in accordance with the present invention when used for the preparation of very large circular pizzas as well as very large rectangular may make the handling of a monolithic preformed slice awkward. Accordingly, the preformed slice may be formed in two or even more sections. For example, as best shown in FIGS. 3 and 4 the preformed slice may be composed of discrete sections of the final preformed slice that is applied to the crust. As shown in those figures the sections may be identical and each will be 180° quadrant of the full preform slice. Similarly, the preformed slice for use in preparation of very large rectangular pizzas may be formed with multiple sections. Normally, the respective sections will collectively have the overall shape and thickness of a monolithic preformed slice.

Still other embodiments of the present invention may utilize an extrusion process whereby cheeses forced through a rectangular slot having dimensions corresponding to the cross section of a given preformed slice. Periodically, a knife cuts axial sections from the elongated extrusion. Thereafter, a press forms the required holes in the preformed slice as well as trims the corners in the case of preformed slice or preformed slice section for use with a circular pizza. In the case of a rectangular pizza no trimming of the size of the preformed slice will be necessary.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for preparation of a pizza which comprises:
providing a crust having a peripheral edge providing a preformed slice of cheese having a substantially uniform thickness dimensioned and configured to extend over the crust and intermediate the peripheral edge thereof and having a plurality of holes disposed therein;
positioning the preformed slice of cheese on the crust;
baking the crust and the preformed slice whereby gases trapped intermediate the preformed slice and the crust escape out through the holes in the preformed slice.

2. The method as described in claim 1 wherein said holes are arranged in a grid.

3. The method as described in claim 1 wherein said holes are arranged in concentric rings.

4. The method as described in claim 1 wherein said holes have a diameter of approximately ¼ inch.

5. The method as described in claim 1 wherein said holes are spaced apart no less than one half inch.

6. The method as described in claim 1 wherein the ratio of the distance between holes and the diameter of the holes is approximately 2:1.

7. The method as described in claim 1 wherein the step of providing a preformed slice of cheese provides a monolithic piece.

8. The method as described in claim 1 wherein the step of providing a preformed slice of cheese provides a plurality of sections that when placed in side abutting relationship collectively are the preformed slice.

9. The method as described in claim 1 wherein the step of providing a preformed slice of cheese provides a plurality of sections that are each in the shape of 180 degree quadrants that when placed in side abutting relationship collectively are the preformed slice.
